(19) United States
(12) Patent Application Publication
(10) Pub. No.: US 2007/0051335 A1
(43) Pub. Date: Mar. 8, 2007

(54) Plug valve with lubrication means

(76) Inventor: Francesco Cassina, Milano (IT)

Correspondence Address: Modiano & Associati;Via Meravigl, 16, 20123 Milano, Milan, IT

(21) Appl. No.: 10/574,480

(22) PCT Filed: Oct. 19, 2004
(86) PCT No.: PCT/IB04/03431

§ 371 Date: Apr. 3, 2006

(30) Foreign Application Priority Data
Oct. 20, 2003 (IT) MI2003A002035

(51) Int. Cl. F16K 5/22

(52) U.S. Cl. 123/190.16

(57) ABSTRACT

A plug valve with improved lubrication elements comprising a valve body, which forms a seat that is connected to an intake port and to a discharge port, and accommodates a plug-type flow control element that controls the ports. Lubrication elements are further provided between the seat and the plug-type flow control element; the plug valve further comprising at least one pair of open lubrication channels, which are provided diametrically in the plug-type flow control element, and at least one pair of open lubrication ducts, which are provided diametrically in the seat. The pair of open channels is always in contact with the seat during the transfer of the plug-type flow control element from the open position to the closed position, and/or vice versa.

### TECHNICAL FIELD

The present invention relates to a plug valve with improved lubrication means.

### BACKGROUND ART

As is known, various kinds of lubricated-plug valves are already commercially available and generally comprise a valve body, which forms a seat that is connected to an intake port and a discharge port. The seat rotatably accommodates a plug-type flow control element, which is substantially frustum-shaped and controls said intake and discharge ports and is provided with lubrication means, generally constituted by two pairs of open channels, which are arranged diametrically and are distributed circumferentially and in which the lubricating grease is arranged.

With this type of embodiment, in passing from the closed position to the open position and/or vice versa, one pair of lubrication channels makes contact with the fluid that flows in the valve, and therefore there is a mutual contamination between the fluid and the lubrication grease.

Moreover, since the process fluid affects the lubrication channels, inevitably part of the lubricating grease is removed, accordingly requiring frequent maintenance due to dispersion of lubricating grease in the process fluid.

### SUMMARY OF THE INVENTION

The aim of the invention is to solve the problem noted above, by providing a plug valve with improved lubrication means that allows to prevent the dispersion of lubricating grease in the process fluids, preventing the process fluids from making direct contact with the lubrication systems.

Within this aim, an object of the invention is to provide a plug valve that is interchangeable with ball valves, since the same gauges and identical line connections are used.

Another object of the present invention is to provide a plug valve that has an excellent performance in erosive and corrosive environments, such as mines, refineries and the like, and further provides optimum tightness and durability of said valve.

Another object of the present invention is to provide a plug valve that is capable of giving the greatest assurances of reliability and safety in use thanks to its particular constructive characteristics.

Another object of the present invention is to provide a plug valve that can be obtained easily starting from commonly commercially available elements and materials and is also competitive from a merely economical standpoint.

This aim and these and other objects that will become better apparent hereinafter are achieved by a plug valve with improved lubrication means, according to the invention, which comprises a valve body, which forms a seat that is connected to an intake port and a discharge port, and accommodates a plug-type flow control element that controls said ports, lubrication means being further provided between said seat and said plug-type flow control element, characterized in that said lubrication means comprise at least one pair of open lubrication channels, which are provided diametrically in said plug-type flow control element, and at least one pair of open lubrication ducts, which are provided diametrically in said seat, said at least one pair of open channels being always in contact with said seat during the transfer of said plug-type flow control element from the open position to the closed position, and/or vice versa.

### BRIEF DESCRIPTION OF THE DRAWINGS

Further characteristics and advantages of the invention will become better apparent from the description of a preferred but not exclusive embodiment of a plug valve with improved lubrication means, illustrated by way of non-limiting example in the accompanying drawings, wherein:

FIG. 1 is a sectional exploded view of the plug valve, taken along a longitudinal plane that passes through the axis of the flow control element;

FIG. 2 is a sectional exploded view of the plug valve, taken along a transverse plane that passes through the axis of the flow control element;

FIG. 3 is a schematic sectional view of the plug valve, taken along a plane that is perpendicular to the axis of the flow control element;

FIG. 4 is a sectional view of a detail of the valve in the closed position, taken along a plane that is perpendicular to the axis of the flow control element;

FIG. 5 is a sectional view of the valve in a partially open position;

FIG. 6 is an enlarged-scale view of the detail of the lubrication means.

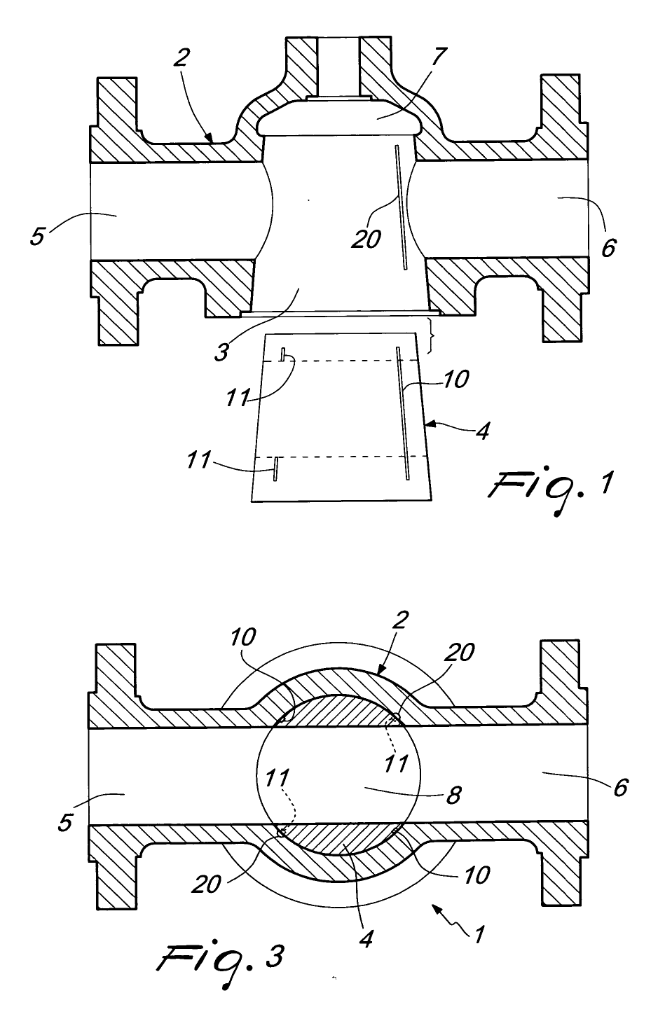

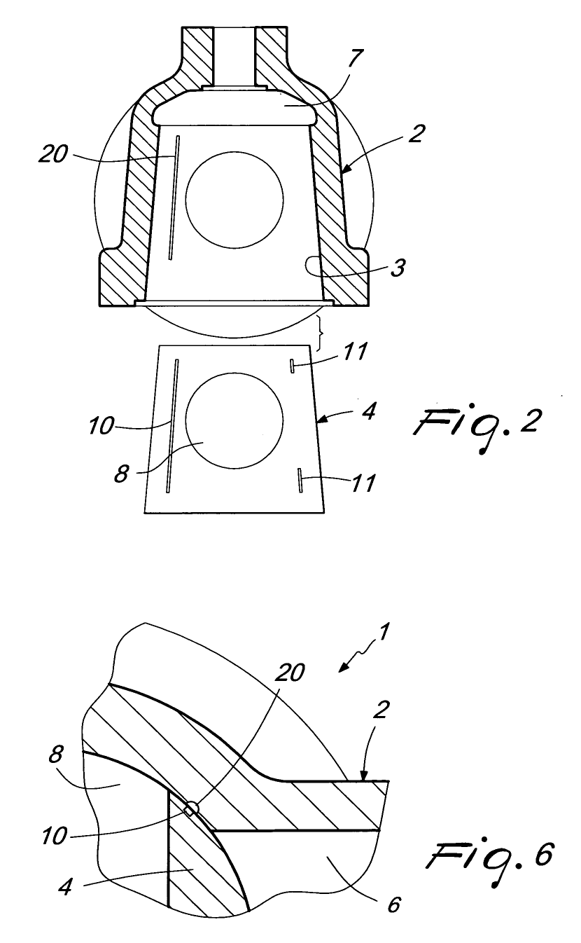

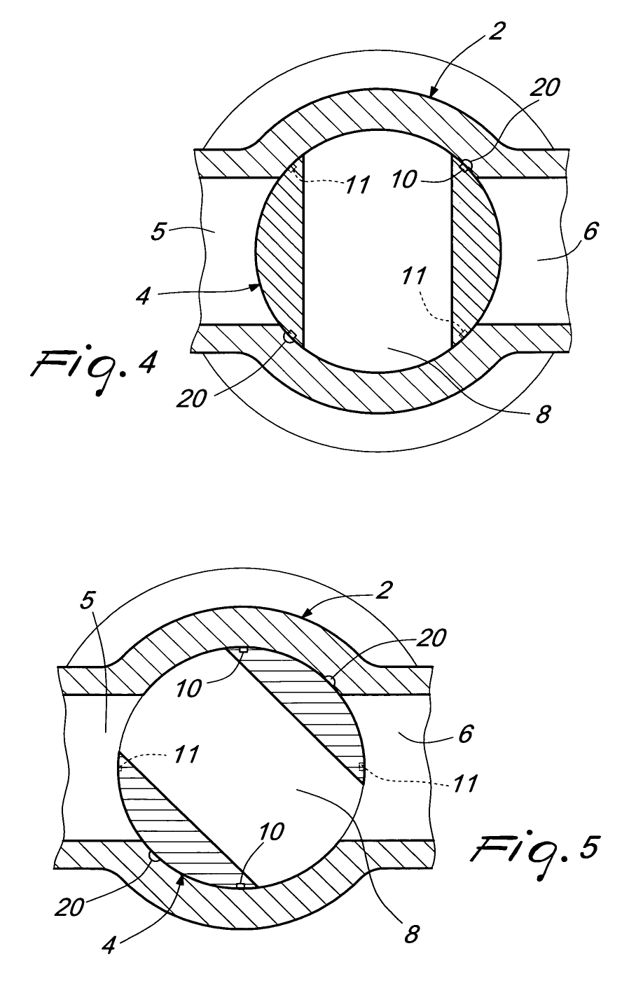

### WAYS OF CARRYING OUT THE INVENTION

With reference to figures, the plug valve with improved lubrication means, according to the invention, generally designated by the reference numeral 1, comprises a valve body 2, which forms a frustum-shaped seat 3 for accommodating a plug-type flow control element, which is generally designated by the reference numeral 4.

The seat 3 is connected to an intake port 5 and a discharge port 6, which are arranged diametrically with respect to each other: moreover, at the upper part of the seat 3, a tank 7 for containing the lubricating grease is provided.

The flow control element 4 is provided with a through channel 8 which has a full cross-section, so that its passage aperture matches the passage aperture of the ports 5 and 6; moreover, the gauge for connecting the valve body 2 to the line is identical to the gauge of ball valves, thus allowing easy interchangeability.

Lubrication means act between the seat 3 and the flow control element 4 and have the particularity of having two open lubrication channels, designated by the reference numeral 10, which are arranged diametrically on the flow control element 4 and run substantially along the entire height of the generatrices of the frustum-shaped surface of the flow control element.

Discontinuous lubrication channels are also provided, designated by the reference numeral 11, which are offset with respect to the channels 10 and are arranged so as to, not affect the apertures formed by the intake port 5 and the discharge port 6 during use of the flow control element with rotation from the closed position to the open position and/or vice versa.

Two open lubrication ducts, designated by the reference numeral 20, are provided on the seat 3 and are arranged diametrically with respect to each other; when the flow control element is in the closed position, said ducts are offset and distributed symmetrically with respect to the channels 10, as shown in FIG. 3.

An important characteristic of the mutual arrangement is the fact that the lubrication channels 10 remain in contact with the frustum-shaped surface of the receptacle 3 in passing from the open position to the closed position, and/or vice versa.

In this way, the fluid in transit in the valve does not make contact with the lubrication channels, thus preventing mutual contamination and dispersion of the grease in the process fluid.

As shown in the figures, when the flow control element 4 is in the closed position, the channels 10 are arranged at the ducts 20, thus allowing better grease distribution.

The discontinuous channels 11 are provided in such a way that they do not affect the apertures of the ports 5 and 6 and therefore no contamination of any kind occurs in these channels as well.

It should also be specified that the discontinuous channels might optionally be omitted whenever the lubrication obtained with the channels 10 and with the ducts 20 is inherently sufficient.

From what has been described above, it is thus evident that the invention achieves the intended aim and objects, and in particular the fact is stressed that a plug valve with a full aperture, i.e., with a through channel that matches the aperture of the intake and discharge ports, is provided which in addition to having the same gauge as ball valves also allows to improve the lubrication characteristics considerably, since the channels and ducts for lubrication can never be affected directly by the fluids in transit both during transition between opening and closure and/or vice versa of the valve, and when the valve is kept partially open.

The invention thus conceived is susceptible of numerous modifications and variations, all of which are within the scope of the appended claims.

All the details may further be replaced with other technically equivalent elements.

In practice, the materials used, as well as the contingent shapes and dimensions, may be any according to requirements.

The disclosures in Italian Patent Application no. MI2003A002035, from which this application claims priority, are incorporated herein by reference.

What is claimed is:

1-7. (canceled)

8. A plug valve with improved lubrication means, comprising a valve body, which forms a seat that is connected to an intake port and a discharge port, and accommodates a plug-type flow control element that controls said ports, lubrication means being further provided between said seat and said plug-type flow control element, wherein said lubrication means comprise at least one pair of open lubrication channels, which are provided diametrically in said plug-type flow control element, and at least one pair of open lubrication ducts, which are provided diametrically in said seat, said at least one pair of open channels being always in contact with said seat during the transfer of said plug-type flow control element from the open position to the closed position, and/or vice versa.

9. The plug valve according to claim 8, wherein said plug-type flow control element is substantially frustum-shaped, with a through channel having a full cross-section that substantially coincides with the passage aperture formed by said ports.

10. The plug valve according to claim 8, wherein the gauge of the connection of said valve body to the line is substantially identical to the gauge of ball valves.

11. The plug valve according to claim 8, wherein said open lubrication channels are arranged substantially along the generatrices of the surface of said plug-type flow control element.

12. The plug valve according to claim 8, comprising, on said plug-type flow control element, discontinuous lubrication channels, which are offset with respect to said open lubrication channels and are arranged so as to not affect the apertures formed by said ports during the rotation of said plug-type flow control element.

13. The plug valve according to claim 12, wherein said discontinuous lubrication channels are arranged symmetrically with respect
